(19) United States
(12) Patent Application Publication
(10) Pub. No.: US 2014/0045557 A1
(43) Pub. Date: Feb. 13, 2014

(54) MOBILE TELEPHONE CASE

(71) Applicant: CHANSEOL CHUNG, HOLLYWOOD, FL (US)

(72) Inventor: CHANSEOL CHUNG, HOLLYWOOD, FL (US)

(73) Assignee: MARWARE, INC., HOLLYWOOD, FL (US)

(21) Appl. No.: 13/571,939

(22) Filed: Aug. 10, 2012

(51) Int. Cl. H04M 1/00

(52) U.S. Cl. 455/575.1

(57) ABSTRACT

A mobile telephone case includes an upper part configured to at least partly cover a rear and sides of an upper portion of a mobile telephone, a lower part configured to at least partly cover a rear and sides of a lower portion of the mobile telephone and a center part configured to at least partly cover a rear and sides of a center portion of the mobile telephone. Snap-locking mechanisms are each configured to lock the center part to a respective one of the upper and lower parts, so as to cover the rear and sides of the mobile telephone in an assembled condition of the case. A plurality of interchangeable center parts may be provided with different patterns, colors, textures or indicia.

### BACKGROUND OF THE INVENTION

1. Field of the Invention

The invention relates to a case for a mobile telephone, such as the iPhone produced by Apple. The iPhone and other so-called smart phones combine a mobile telephone, digital multimedia player and camera and have a multi-touch screen with a virtual or actual keyboard and buttons as well as various ports, such as for charging, USB connection and ear bud connection.

2. Description of the Related Art

Mobile telephones have become indispensable items for large segments of the population. Therefore, the desire is to be able to use the mobile telephone during various activities, such as walking, jogging, working out, driving an automobile or riding a bicycle, etc. The mobile telephone also should be protected from shock and soiling. Accordingly, there is a need for a versatile and protective case which at the same time is able to change its appearance based on the occasion.

### BRIEF SUMMARY OF THE INVENTION

It is accordingly an object of the invention to provide a mobile telephone case, which overcomes the hereinafore-mentioned disadvantages of the heretofore-known devices of this general type and which is versatile in its use and appearance while simultaneously protecting the mobile telephone from shock, damage and soiling.

With the foregoing and other objects in view there is provided, in accordance with the invention, a mobile telephone case, comprising an upper part configured to at least partly cover a rear and sides of an upper portion of a mobile telephone, a lower part configured to at least partly cover a rear and sides of a lower portion of the mobile telephone and a center part configured to at least partly cover a rear and sides of a center portion of the mobile telephone. Locking mechanisms are each configured to lock the center part to a respective one of the upper and lower parts so as to cover the rear and sides of the mobile telephone in an assembled condition of the case. The case of the invention provides a simple structure, having only three parts, for reliably protecting a mobile phone from damage, shock and soiling, because the phone itself within the assembled case provides support for the parts of the case and maintains its integrity, without requiring complicated measures.

In accordance with another feature of the invention, a front of the mobile telephone remains substantially exposed in the assembled condition of the case. This allows the user of the phone to access all of the touch screen features of the phone.

In accordance with a further feature of the invention, the locking mechanisms, which are preferably snap-locking mechanisms, include cooperating openings and detents. In one embodiment, the openings are formed in the upper and lower parts and the detents are formed on the center part, although the opposite can be the case as well. This structure provides a particularly robust snapping-together and locking of the parts.

In accordance with an added feature of the invention, the upper and lower parts each have a respective extension with the openings formed therein and the center part has recessed edges with the detents formed thereon. Each of the recessed edges is adjacent a respective one of the extensions and the detents are engaged in the openings, in the assembled condition of the case. In addition, each of the recessed edges covers a respective one of the extensions in the assembled condition of the case. This allows the openings and detents to be hidden although, as mentioned above, the locations of the openings and detents can be reversed.

In accordance with an additional feature of the invention, the center part is formed of resilient material permitting the center part to be deformed and snap back to partly surround the upper and lower parts and lock the locking mechanisms in the assembled condition of the case. Although the upper and lower parts can also be formed of resilient material, when the center part covers the edges of the upper and lower parts, it is particularly preferable for the center part to be resilient so that it can snap on top.

In accordance with yet another feature of the invention, the upper, lower and center parts each have two respective flanges together covering the sides of the mobile telephone and forming a peripheral bead disposed at the front of the mobile telephone, in the assembled condition of the case. The relatively small part of the case represented by the bead at the front of the mobile phone provides a particularly good hold for the case on the phone and thus a particularly good interconnection of the parts of the case, without hiding the touch screen.

In accordance with a concomitant feature of the invention, the center part has an outer surface with at least one of a pattern, color, texture or indicia differing from remaining regions of the case. Alternatively, at least one additional center part is provided, the center parts are interchangeable and each has an outer surface with a different pattern, color, texture or indicia. This allows the center part to have a different appearance from the rest of the phone and it also allows a consumer to easily change the appearance of the phone by exchanging center parts.

Other features which are considered as characteristic for the invention are set forth in the appended claims.

Although the invention is illustrated and described herein as embodied in a mobile telephone case, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, right side and rear-perspective view of a first embodiment of a mobile telephone case according to the invention, in an assembled condition on a mobile phone;

FIG. 2 is a top-plan view of the assembled case;

FIG. 3 is a front-elevational view of the assembled case;

FIG. 4 is a bottom-plan view of the assembled case;

FIG. 5 is a left side-elevational view of the assembled case;

FIG. 6 is a right side-elevational view of the assembled case;

FIG. 7 is a rear-elevational view of the assembled case;

FIG. 8 is a partially-assembled, perspective view illustrating the manner of taking the case off and putting the case on the phone;

FIG. 9 is an exploded, perspective view of the case and a phone;

FIG. 10 is an exploded, rear-elevational view of the case and a phone;

FIG. 11 is a left side-elevational view and FIGS. 12-15 are views similar to FIGS. 2-5, of a second embodiment having a pattern on a center part of the case; and

FIGS. 16, 17, 18 and 19 are respective rear-elevational, rear-perspective, exploded-perspective and exploded, rear-elevational views of the second embodiment of the case.

### DETAILED DESCRIPTION OF THE INVENTION

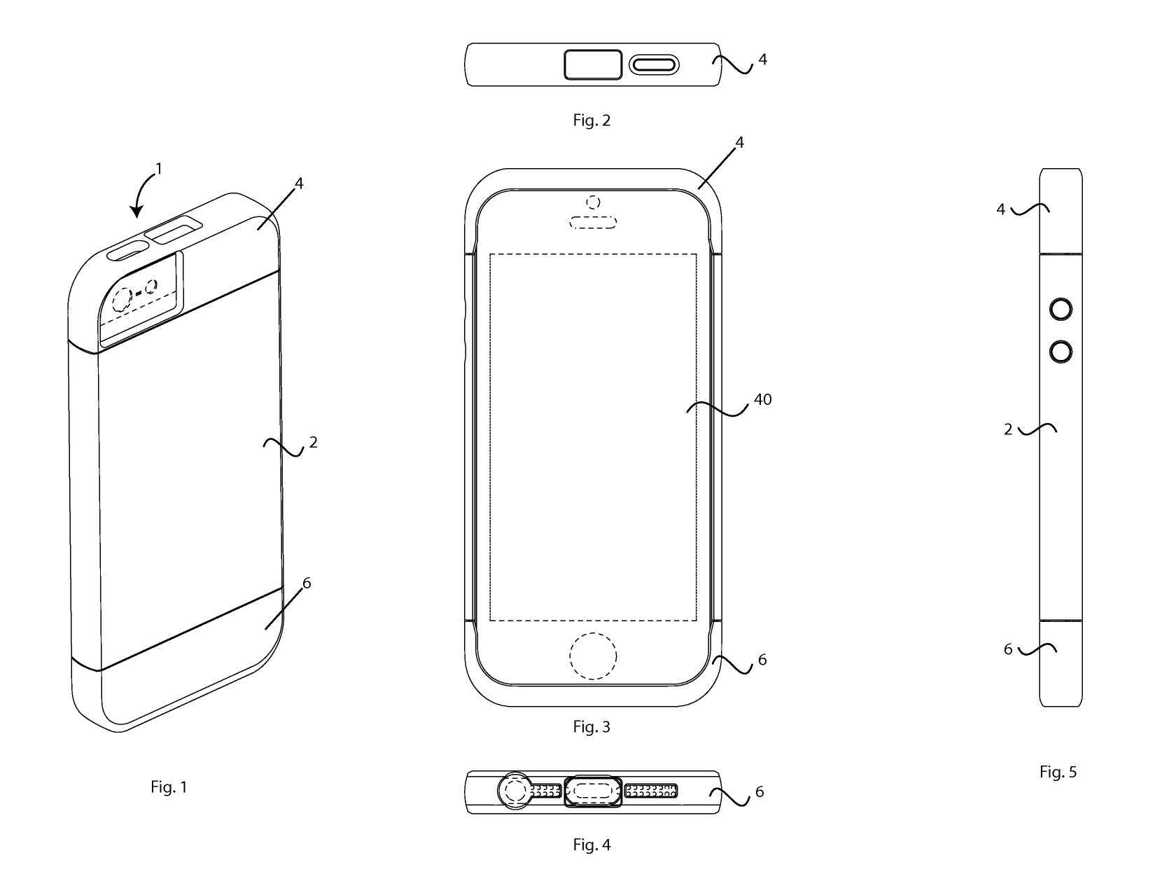

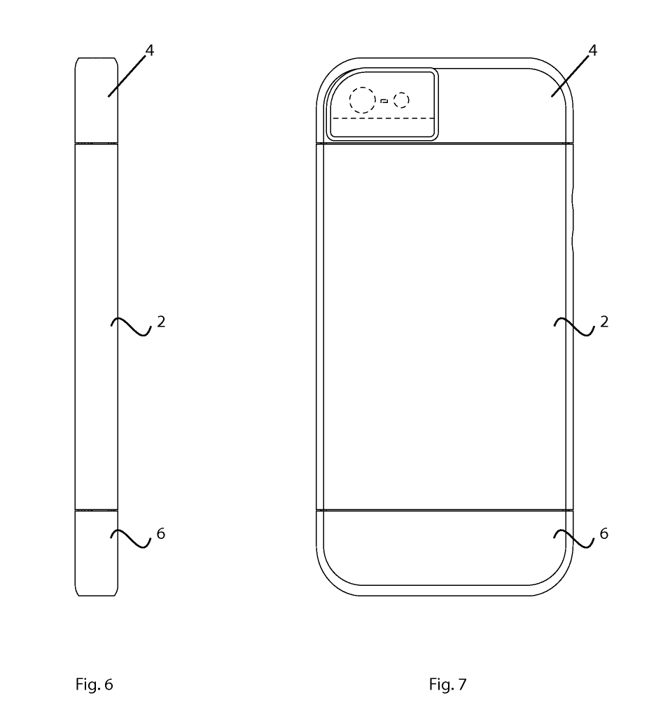

Referring now to the figures of the drawing in detail and first, particularly, to FIGS. 1-7 thereof, there is seen a first embodiment of a mobile telephone case 1 according to the invention. The case 1 is shown in an assembled condition on a mobile telephone 40 illustrated in broken lines, in this case an iPhone® which is used as an example. The case includes three parts, a center part 2, a top part 4 and a bottom part 6. At least the center part and preferably all of the parts are made of a rigid yet resilient plastic material. Each of the three parts 2, 4, 6 has various openings for accessing ports and/or buttons on the phone 40. The openings vary in size, shape and location in dependence on the make and model of the phone intended to be enclosed by the case. It may also be seen that the rear of the case shown in FIG. 1 almost completely encloses the rear of the mobile telephone 40, whereas the front of the case shown in FIG. 3 wraps slightly around the front edges of the mobile telephone 40, but leaves the front of the phone mostly exposed for operation.

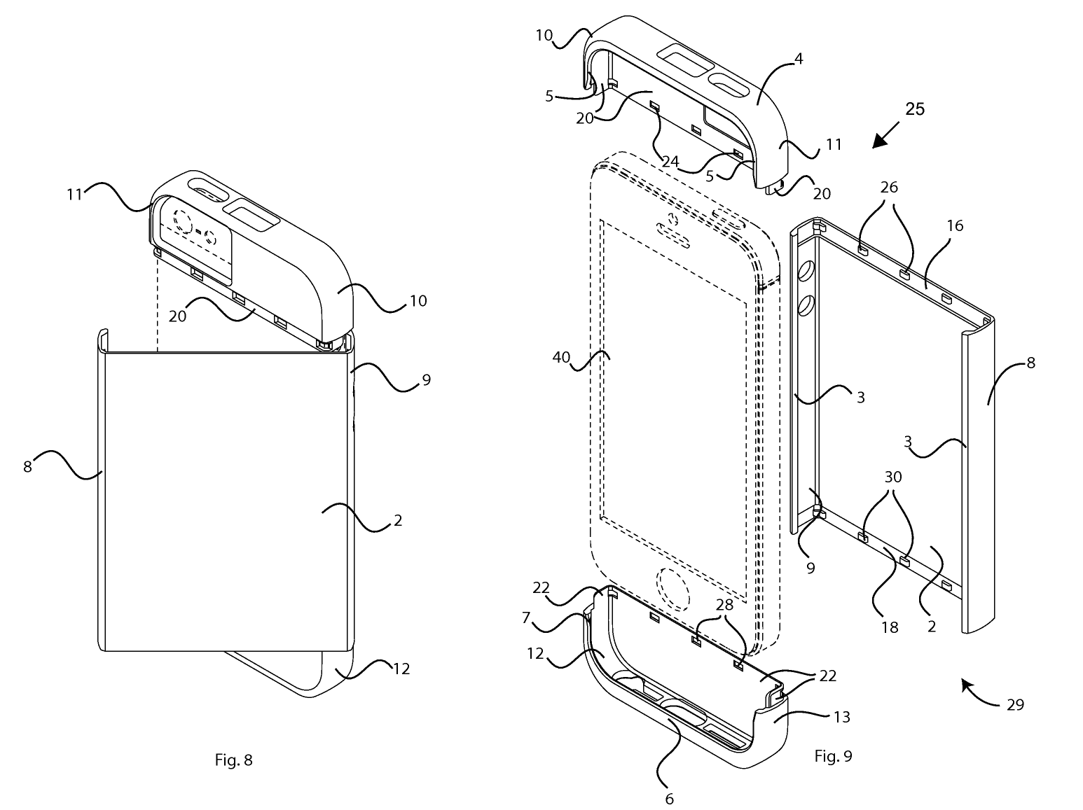

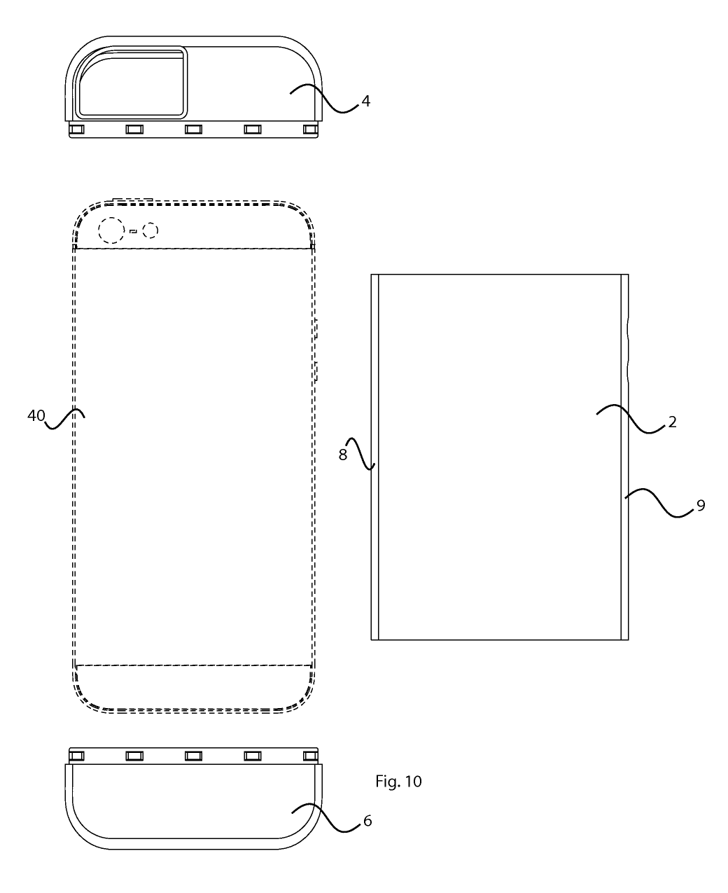

FIGS. 8-10 illustrate the case and the manner of assembly and disassembly thereof in more detail. It can be seen therefrom that the center part 2 has flanges 8, 9 which wrap around the sides of the phone 40 and mate with flanges 10, 11 and 12, 13 of the respective upper and lower parts 2, 4 of the case 1. The mating takes place through the use of recessed edges 16, 18 at the top and bottom of the center part 2 which are engaged by extensions 20, 22 of the respective upper and lower parts 2, 4 of the case 1. The upper part 4 has a series of openings 24 formed therein to be engaged by a series of detents 26 on an inner surface of the recessed edge 16 forming an upper locking mechanism 25. The lower part 6 has a series of openings 28 formed therein to be engaged by a series of detents 30 on an inner surface of the recessed edge 18 forming a lower locking mechanism 29.

The flanges of the center, upper and lower parts 2, 4, 6 each have a respective bead 3, 5, 7 together forming a peripheral bead disposed at the front of the mobile telephone 40, in the assembled condition of the case 1, which holds the telephone within the case.

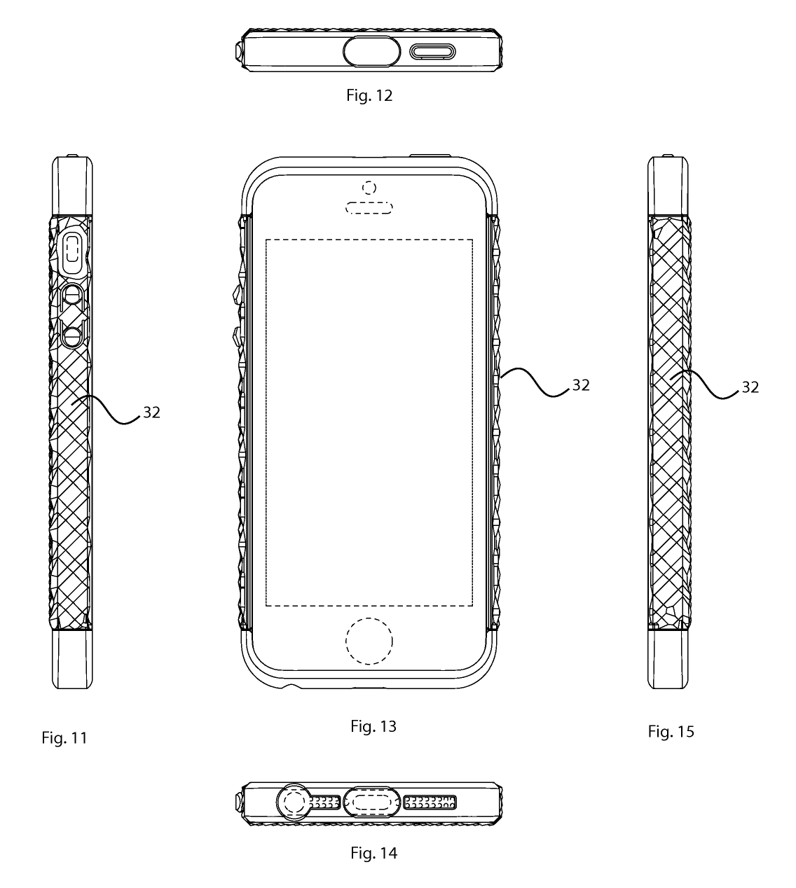

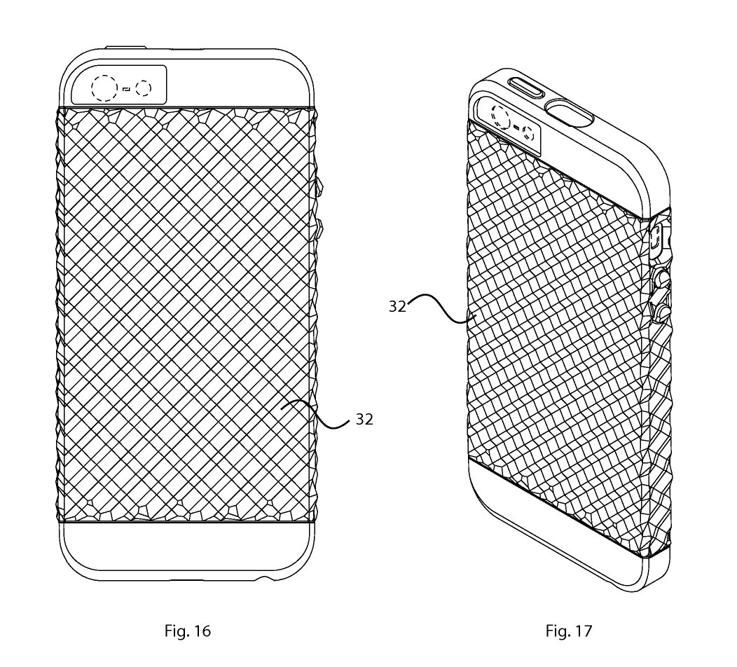

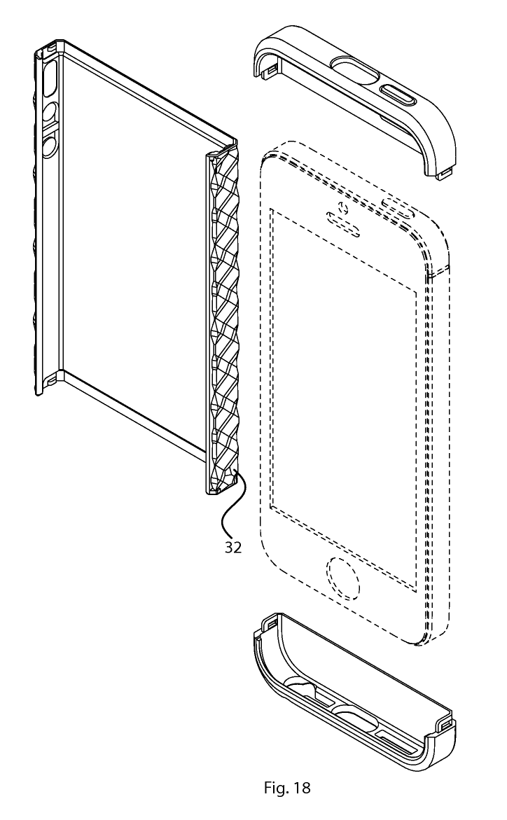

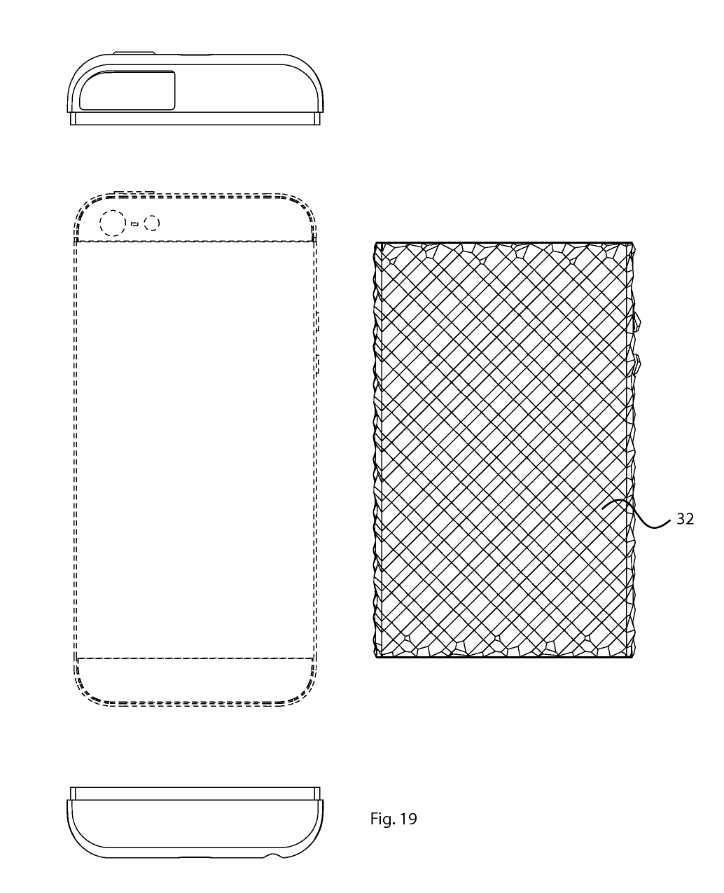

The second embodiment illustrated in FIGS. 11-19 differs from the first embodiment of FIGS. 1-10 in that a pattern 32 is formed in or applied on the center part of the case. It is within the scope of the invention to provide a set of center parts having different patterns 32, which can be exchanged so that the user of the case can select a center part with a pattern, color, texture or indicia, such as a logo, that is suitable for a particular occasion. For example, a designer pattern or a team logo may be selected and easily changed.

The case 1 of the invention is assembled by first placing the upper and lower parts 4, 6 on the top and bottom of the mobile telephone 40, as end caps. The center part 2 is then slightly spread apart and deformed like a shell by pulling the flanges away from each other with the thumbs and the center part is then snapped over the mobile telephone 40 and the end caps 4, 6 so that the detents 26, 30 snap into the respective openings 24, 26 from the outside and hold the three parts of the case together. The locking mechanisms 25, 29 are therefore snap-locking mechanisms. The mobile telephone 40 itself keeps the three parts together by bearing against the case from the inside, until the flanges 8, 9 are once again pried apart.

1. A mobile telephone case, comprising:
an upper part configured to at least partly cover a rear and sides of an upper portion of a mobile telephone;
a lower part configured to at least partly cover a rear and sides of a lower portion of the mobile telephone;
a center part configured to at least partly cover a rear and sides of a center portion of the mobile telephone; and
locking mechanisms each configured to lock said center part to a respective one of said upper and lower parts covering the rear and sides of the mobile telephone in an assembled condition of the case.

2. The mobile telephone case according to claim 1, wherein a front of the mobile telephone remains substantially exposed in the assembled condition of the case.

3. The mobile telephone case according to claim 1, wherein said locking mechanisms include cooperating openings and detents.

4. The mobile telephone case according to claim 3, wherein said openings are formed in said upper and lower parts and said detents are formed on said center part.

5. The mobile telephone case according to claim 3, wherein:
said upper and lower parts each have a respective extension with said openings formed therein;
said center part has recessed edges with said detents formed thereon; and
each of said recessed edges is adjacent a respective one of said extensions and said detents are engaged in said openings, in the assembled condition of the case.

6. The mobile telephone case according to claim 5, wherein each of said recessed edges covers a respective one of said extensions in the assembled condition of the case.

7. The mobile telephone case according to claim 1, wherein said center part is formed of resilient material permitting said center part to be deformed and to snap back to partly surround said upper and lower parts and lock said locking mechanisms in the assembled condition of the case.

8. The mobile telephone case according to claim 3, wherein said locking mechanisms are snap-locking mechanisms.

9. The mobile telephone case according to claim 1, wherein said upper, lower and center parts each have two respective flanges together covering the sides of the mobile telephone and forming a peripheral bead disposed at the front of the mobile telephone, in the assembled condition of the case.

10. The mobile telephone case according to claim 1, wherein said center part has an outer surface with at least one of a pattern, color, texture or indicia differing from remaining regions of the case.

11. The mobile telephone case according to claim 1, which further comprises at least one additional center part, said center parts being interchangeable and each having an outer surface with a different pattern, color, texture or indicia.
